(19) United States
(12) Patent Application Publication
(10) Pub. No.: US 2009/0212997 A1
(43) Pub. Date: Aug. 27, 2009

(54) Method for measuring a distance running time

(75) Inventor: Bernhard Michalski, Maulburg (DE)

Correspondence Address: BACON & THOMAS, PLLC, 625 SLATERS LANE, FOURTH FLOOR, ALEXANDRIA, VA, 22314-1176, US

(73) Assignee: Endress + Hauser GmbH + Co. KG, Maulburg (DE)

(21) Appl. No.: 11/918,855

(22) PCT Filed: Apr. 21, 2006
(86) PCT No.: PCT/EP2006/061735

§ 371 Date: Jan. 14, 2009

(30) Foreign Application Priority Data
May 4, 2005 (DE) 10 2005 021 358.8

(51) Int. Cl. G01S 13/08

(52) U.S. Cl. 342/137

(57) ABSTRACT

A method for ascertaining the distance on the basis of the travel-time of high-frequency measuring signals, wherein at least one periodic, pulsed, transmission signal having a pulse repetition frequency is transmitted and at least one reflected measuring signal is received. The transmission signal and the reflected measuring signal are transformed by means of a sampling signal produced with a sampling frequency into a time-expanded, intermediate-frequency signal having an intermediate-frequency. The time-expanded, intermediate-frequency signal is filtered by means of at least one filter and a filtered, intermediate-frequency signal is produced, wherein the intermediate-frequency is matched to a limit frequency and/or a center frequency of the filter. The matching of the filter to the intermediate-frequency of the time-expanded measuring signal results, reducing production costs.

The present invention relates to a method for ascertaining distance on the basis of travel-time of high-frequency measuring signals.

Measuring devices are frequently used in automation and process control technology for ascertaining, during the course of a process, a process variable, such as, for example, flow, e.g. flow rate, fill level, pressure and temperature or some other physical and/or chemical variable. The present assignee produces and sells, among a variety of measuring devices, measuring devices under the marks Micropilot, Prosonic and Levelflex, which work according to the travel-time measuring method and serve for determining and/or monitoring fill level of a medium in a container. In the case of the travel-time measuring method, for example, ultrasonic waves are transmitted via a sound transducer, or microwaves, or radar waves, are transmitted via an antenna, or guided along a waveguide extending into the medium. Echo waves reflected on the surface of the medium are then received back by the measuring device, following a distance-dependent travel-time of the signal. From half the travel-time, the fill level of the medium in a container can then be calculated. The echo curve represents, in such case, the received signal amplitude as a function of time, with each measured value of the echo curve corresponding to the amplitude of an echo curve signal reflected on a surface a certain distance away. The travel-time measuring method is divided into essentially two ascertainment methods: Time-difference measurement, which requires a pulse-modulated wave signal for the traveled path; and, as another widely used ascertainment method, measuring the sweep frequency difference of a transmitted, continuous, high-frequency signal relative to a reflected, received, high-frequency signal (FMCW—Frequency-Modulated Continuous Wave). In the following, there is no limitation to a special ascertainment method. Instead, the underlying travel-time method will be considered as the measuring principle.

The received measuring signals contain, most likely, under real measuring conditions, additionally, disturbance, or noise, signals. These disturbance signals arise from various causes and can be categorized e.g. as

white noise, shot noise

1/f noise, or flicker noise

phase noise

noise from sequential sampling with a sampling circuit

noise from filling and emptying procedures

dispersion of transmitted waves

foam- and accretion-building of the medium

moisture in the atmosphere in the container

turbulent surface on the medium

stray in-coming electromagnetic radiation.

In the present state of the art, there are various attempts to remove the disturbance, or noise, signals, since these unwanted signals can make more difficult, or prevent, evaluation and determining of fill level, in that they can hide the measuring signal.

As one approach for separating disturbance signals from the measuring signal, DE 199 49 992 C2 proposes a method for ascertaining a disturbance measure in the measuring signal. From the disturbance measure and the measuring signal, it is calculated, according to an algorithm, whether a sufficient measuring accuracy of the measuring signal is present. This current disturbance measure is compared with other disturbance measures recorded in other frequency ranges and stored, for example in a memory. Depending on strength of the disturbance measure and ascertained measuring accuracy of the measuring signal, another frequency range can be used, in which the disturbances of the measuring signal are less. In such method, an evaluation of the measuring accuracy of the measuring signal is made and a decision is reached, whether this measuring signal can be used or whether a new measurement in another frequency range is more suitable.

Another approach is to filter-out the disturbance, or noise, signals of the sampled, time-expanded measuring signal, or intermediate-frequency, by filtering with a bandpass of high quality. For this, a narrow-banded bandpass of high quality is used, whose center frequency matches the intermediate-frequency of the sampled measuring signal. This center frequency of the bandpass is, according to the current state of the art, matched to the selected, fixed intermediate-frequency using an adjustable component, e.g. a tuning coil.

Since this center frequency of the bandpass of the filter stage depends on component tolerances of the bandpass and the disturbing influences, such as e.g. temperature movements, this is different from case to case, so that the bandpass must be tuned to the desired metal frequency using a variable component (e.g. tuning coil). This tuning of the bandpass is done in the end phase of the production of the measuring device and is very cost-intensive, due to the additionally used, expensive components, such as e.g. HF-tuning coils, as well as due to the additional working time required for the individual tuning procedures. Furthermore, a changing of the component characteristic and, thus, a drift of the center frequency of the bandpass during operation of the measuring device, e.g. due to temperature influences or aging of the components of the bandpass, can only be counteracted by a manually executed tuning of the bandpass.

An object of the invention, therefore, is to provide an optimized, simple method for improving matching of the filter to the intermediate-frequency of the time-expanded measuring signal, which method reduces the production costs.

This object is achieved according to the invention by a method for ascertaining distance on the basis of travel-time of high-frequency measuring signals, wherein at least one periodic transmission signal having a pulse repetition frequency is transmitted and at least one reflected measuring signal is received, wherein the transmission signal and the reflected measuring signal are transformed by means of a sampling signal produced with a sampling frequency into a time-expanded, intermediate-frequency signal having an intermediate-frequency, wherein the time-expanded, intermediate-frequency signal is filtered by means of at least one filter and a filtered echo curve signal is produced, and wherein the intermediate-frequency is matched to a limit frequency and/or a center frequency of the filter.

An advantageous form of embodiment of the solution of the invention is that wherein the intermediate-frequency is matched by so varying the pulse repetition frequency and/or the sampling frequency, that the frequency difference between the pulse repetition frequency and the sampling frequency is changed.

In an especially preferred form of embodiment of the solution of the invention, it is provided that the intermediate-frequency is matched by varying the pulse repetition frequency and/or the sampling frequency according to an iterative method.

An efficient embodiment of the solution of the invention is that wherein the matching of the intermediate-frequency is checked by evaluating signal strength of the echo curve signal.

An advantageous form of embodiment of the structure of the method of the invention is that wherein the control process for matching the intermediate-frequency is initiated periodically or under event-control.

According to an advantageous form of embodiment of the method of the invention, it is provided that signal strength of the echo curve signal is determined by an algorithm from the echo curve signal, by ascertaining of amplitude of the fill level echo and/or by ascertaining of an integral over all data points of the echo curve signal.

According to an advantageous form of embodiment of the method of the invention, it is provided that a transformation factor corresponding to the time expansion ratio is ascertained from the ratio of the pulse repetition frequency to a frequency difference.

In an advantageous form of embodiment of the method of the invention, it is provided that the transformation factor is transmitted for further evaluation and processing of the filtered, time-expanded echo signal.

A further advantageous form of embodiment of the method of the invention is that wherein mirror frequencies of the intermediate-frequency are masked out of the time-expanded, intermediate-frequency signal by a lowpass filter and/or the sampling sum signal.

A very advantageous variant of the method of the invention is that wherein disturbance signals, especially noise, are masked out of the time-expanded, intermediate-frequency signal by a bandpass filter.

Further advantages of the invention are that measuring accuracy is increased, in that always the maximum possible echo curve signal is ascertained and evaluated and that an autonomous tuning of the measuring device or measuring electronics is possible for changing measuring, or measuring device, conditions, without requiring maintenance personnel. By the method of the invention, a self-sufficient tuning control of the measuring electronics is provided for working against changes resulting from aging, temperature drift of components and/or changed measuring conditions, e.g. measuring range changes.

The invention will now be explained in greater detail on the basis of the appended drawings. For simplification, identical parts in the drawings are provided with equal reference characters. The figures show as follows:

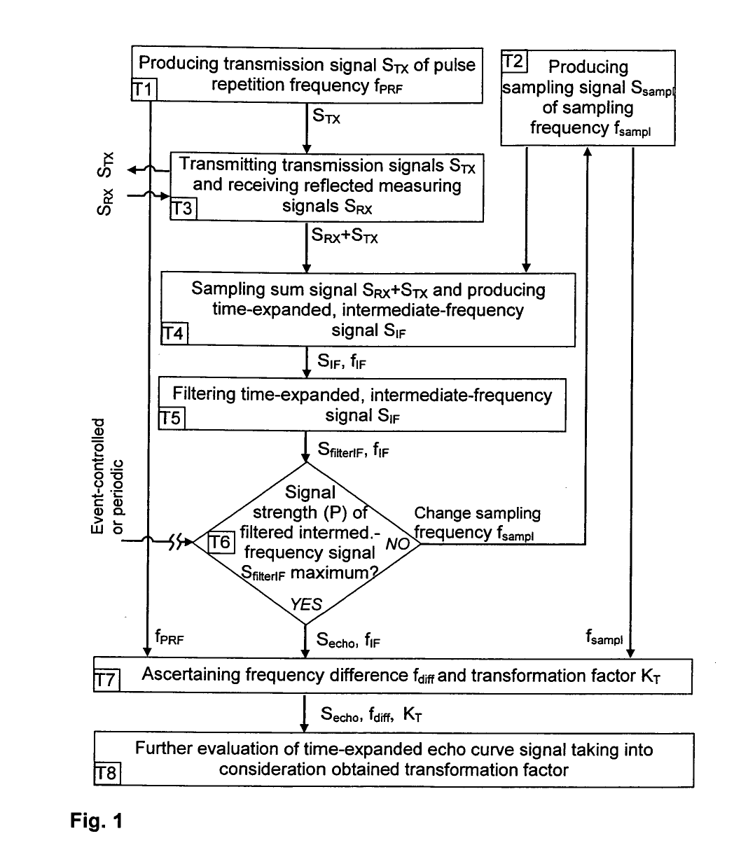

FIG. 1 a flow diagram of the travel-time measuring method of the invention executed in the control circuit of the measuring device;

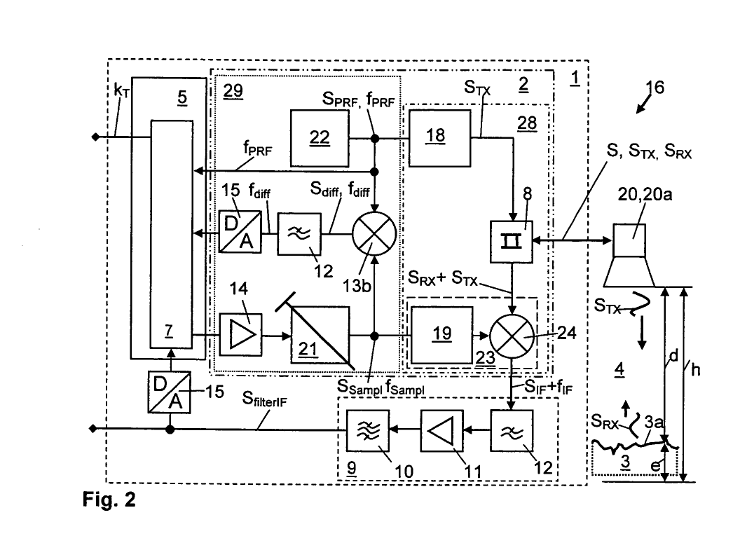

FIG. 2 a first example of an embodiment of a block diagram of an exciter- and measuring-circuit of the measuring device;

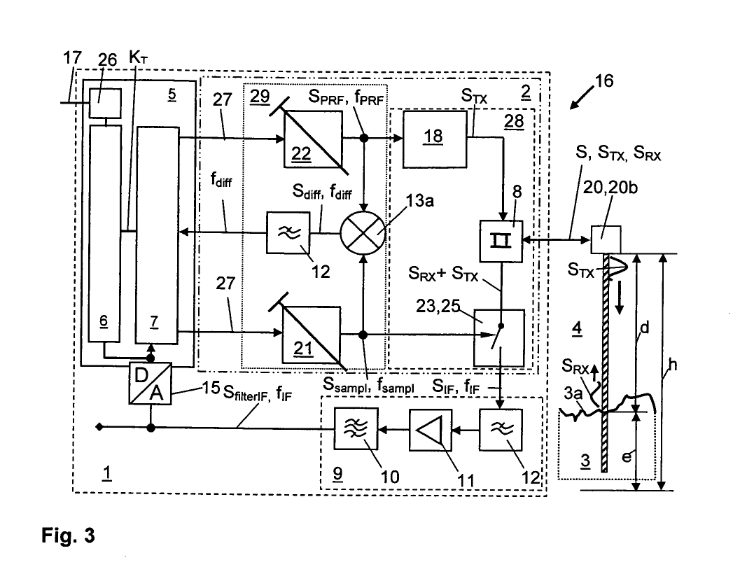

FIG. 3 a second example of an embodiment of a block diagram of an exciter- and measuring-circuit of the measuring device; and

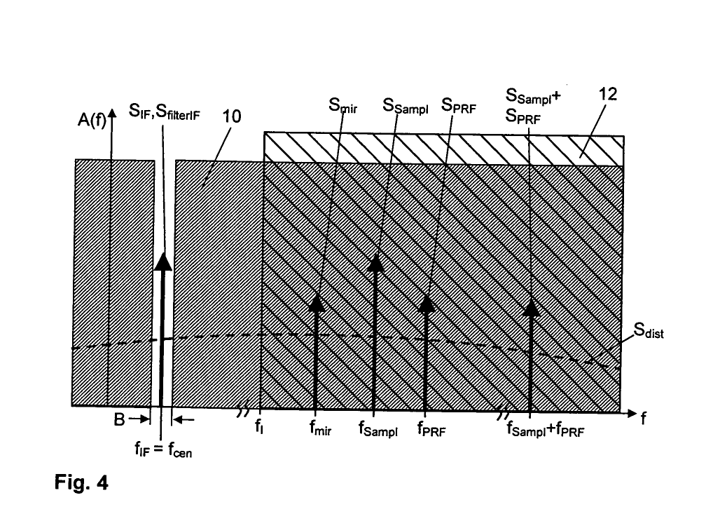

FIG. 4 a schematic frequency spectrum of the intermediate-frequency signal S_{IF} following sequential sampling with corresponding filters.

FIG. 1 shows a first example of an embodiment of a block diagram of the method of the invention for ascertaining distance d, or fill level e on the basis of travel-time t. In a first method step T1, a pulsed transmission signal S_{TX} carried by a high-frequency signal S_{HF} is produced, which is triggered with a pulse repetition signal S_{PRF} having a pulse repetition frequency f_{PRF}. In a second method step T2, a sampling signal Sₛₐₘₚₗ is produced, having a sampling frequency fₛₐₘₚₗ which has a frequency difference f_{diff} relative to the pulse repetition frequency F_{PRF}, but which is also carried by the same high-frequency signal S_{HF}. In the third method step T3, the transmission signal S_{TX} is transmitted and at least one reflected measuring signal S_{RX}, reflected on a surface 3a of the fill substance 3, received. Superimposed on this reflected measuring signal S_{RX} can be a disturbance signal S_{dist} caused by the above-mentioned influences. By a sequential sampling in the fourth method step T4, a time-expanded, intermediate-frequency signal S_{IF} of intermediate-frequency f_{IF} is produced from the signal sum S_{RX}+S_{TX}, for example, by a mixing or sampling with a sampling signal Sₛₐₘₚₗ using a sampling circuit 23. This time-expanded, intermediate-frequency signal S_{IF} is filtered in a fifth method step T5, whereby disturbance signals S_{dist}, which could, additionally, even have been produced by the sampling procedure itself, are removed from the intermediate-frequency signal S_{IF} and an almost disturbance signal free, filtered, intermediate-frequency signal S_{filterIF} of the same intermediate-frequency f_{IF} is produced. In the sixth method step T6, event-controlled or periodically, a check, or test, mode is introduced to determine whether a signal strength P, as ascertained from the filtered intermediate-frequency signal S_{filterIF}, is maximum. An event, which triggers this method step T6, or this check mode, is, for example, a measuring signal amplitude, or signal strength, P lying beneath a predetermined limit value, a change of the medium, or fill substance, 3 in the container, or a fill level change. The ascertaining of the signal strength P from the filtered intermediate-frequency signal S_{filterIF} is done, for example, by determining the amplitude of the fill level echo, or an integral over all data points of the filtered intermediate-frequency signal S_{filterIF} or by an algorithm from the filtered intermediate-frequency signal S_{filterIF}. Also other evaluation criteria of signal strength P of the filtered intermediate-frequency signal S_{filterIF} are usable, such not being explicitly detailed here, and, furthermore, also a phase- or frequency-evaluation of the filtered intermediate-frequency signal S_{filterIF} is also performable for the evaluation. In this check mode or test mode, for example, it is ascertained, whether the signal strength P is maximum. For, if the intermediate-frequency f_{IF} does not lie in the near region of the center frequency f_{cen} of the narrow-banded bandpass 10 or if such is not smaller than the limit frequency fₗ of the lowpass 12 in the filter/amplifier unit 9, as depicted in FIG. 4, then also the intermediate-frequency signal S_{IF} of intermediate-frequency f_{IF} is partially or completely attenuated or depressed in signal strength P by the filters 10, 12. If the signal strength P of the filtered intermediate-frequency signal S_{filterIF} is not maximum, then, for example, according to an optimizing method, an approximation method, or an iteration method, the frequency difference f_{diff} or the sampling frequency fₛₐₘₚₗ is changed until a maximum is found. If the maximum signal strength P of the filtered intermediate-frequency signal S_{filterIF} is reached at a certain intermediate-frequency f_{IF}, then, in a seventh method step T7, the transformation factor K_{T} is ascertained from the frequency difference f_{diff} and the pulse repetition frequency f_{PRF}. In an eighth method step T8, the maximized, filtered, intermediate-frequency signal S_{filterIF} is evaluated taking into consideration the time-expansion, respectively the transformation factor K_{T}; and the travel-time t of a pulse sequence, or burst sequence, is ascertained from the transmission signal S_{TX} and the reflected measuring signal S_{RX}. It is also possible that the eighth method step T8 is executed in each measuring cycle, without, for example, the iterative control process for ascertaining maximum signal strength P, or the tuning of the intermediate-frequency signal f_{IF} to the filter characteristic of the filters 10, 12 being successfully completed. From the travel-time t, with knowledge of the propagation velocity of the transmission signal S_{TX} and reflected measuring signal S_{RX}, the distance d and, thus, with knowledge of the height h of an open or closed spatial system 4, e.g. a container, the fill level e of a fill substance 3 can be determined.

The method of the invention is not limited to travel-time measuring methods with pulsed measuring signals S. Rather, this method can also be used generally for adapting the frequency of the output signal of a mixer 13, 24, or sampling circuit 23, to the limit frequency fₗ or the center frequency f_{cen} of the back- or front-connected filter/amplifier unit 9. Included under the generic term, “measuring signals S”, are the transmission signals S_{TX} and the reflected signals S_{RX}, which are, in particular, composed partially of the pulse repetition signals S_{PRF}, the sampling signals Sₛₐₘₚₗ, and the carrier signals, or high-frequency signals, S_{HF}, as well as also the sampling signal Sₛₐₘₚₗ, difference signal S_{diff} combined for further signal processing.

FIGS. 2 and 3 are examples of embodiments of a measuring device 16 working with high-frequency measuring signals S, especially with microwaves, for determining fill level e of a fill substance 3 in an open or closed, spatial system 4, especially a container.

Measuring device 16 serves for determining a certain fill level e of the fill substance 3 in the open or closed, spatial system 4, especially in the container, based on the pulse radar method, and, by means of an appropriate digital processing unit, especially a microcontroller, 5, for delivering a measured value M especially a digital measured value M, currently representing this fill level e.

For this purpose, measuring device 16 has a transducer element 20, basically connected with the measuring electronics 1. By means of the transducer element 20, the pulsed electromagnetic transmission signal S_{TX} carried by the high frequency signal S_{HF}, the carrier signal, and being of lower frequency in comparison thereto, is coupled into a measuring volume containing the fill substance 3, especially in the direction of the fill substance 3. The average high-frequency f_{HF} of the high-frequency signal S_{HF} or the pulsed transmission signal S_{TX}, lies, here, as is usual in the case of such measuring devices 16 working with microwaves, in a frequency range of several GHz, especially in the frequency range of 0.5 GHz to 30 GHz.

Transducer element 20 can, as shown, for example, in FIG. 2, be an antenna 20a, especially a horn antenna, a rod antenna, a parabolic antenna or a planar antenna, which radiates electromagnetic, high-frequency waves, e.g. microwaves, serving as transmission signal S_{TX}. Instead of such free-space, wave radiators illustrated in FIG. 2, FIG. 3 illustrates that also surface waves guided on the waveguide 20b can be used for fill level measurement. In the case of this method of guided microwaves, referred to as time-domain reflectometry, or the TDR measuring method, for example, a high-frequency pulse is transmitted along a Sommerfeld or Goubau waveguide or coaxial waveguide, to then be partially back-reflected at a discontinuity of the DK (dielectric constant) value of the medium surrounding the waveguide.

Due to impedance jumps within the measuring volume of the open or closed, spatial system 4, or container, especially on the surface 3a of the fill substance 3, the transmission signal S_{TX} is at least partially reflected and, thus, transformed into corresponding reflected measuring signals S_{RX}, which travel back toward the transducer element 20 and are received thereby.

A transmitting/receiving unit 2 coupled to the transducer element 20 serves for producing and processing line-guided and mutually coherent wave packets of predeterminable pulse shape and pulse width, so-called bursts, as well as for generating, by means of the bursts an analog, time-expanded, intermediate-frequency signal S_{IF} influenced by the fill level e. The pulse shape of an individual burst is usually a needle-shaped or sinusoidal, half-wave-shaped pulse of predeterminable pulse width; it is possible, however, also to use other suitable pulse shapes for the bursts.

Measuring electronics 1 is composed, mainly, of at least one transmitting/receiving unit 2, digital processing unit 5, and a filter/amplifier unit 9. The transmitting/receiving unit 2 can, in turn, be considered in terms of an HF-circuit portion 28, in which mainly HF-signals are produced and processed, and an LF-circuit portion 29, in which mainly LF-signals are produced and processed. The individual circuit elements in the HF-circuit portion 28 are built, on the basis of experience, in analog circuit technology, i.e. analog measuring signals S are produced and processed. In contrast, the individual circuit elements in the LF-circuit portion 29 are built either on the basis of digital circuit technology and/or on the basis of analog circuit technology. Considering the rapid progress of digital signal processing, it is also thinkable to embody the HF portion using digital circuit elements. Additionally, the most varied of individual circuit elements are thinkable in digital and analog circuit technology, but all these options should not be detailed explicitly here. Thus, the following description of a form of embodiment is to be considered only as an example of many possible forms of embodiment.

The transmitting/receiving unit 2 includes, according to FIGS. 2 and 3, an electronic transmission-pulse generator 18 for producing a first burst sequence serving as transmission signal S_{TX}. The transmission signal S_{TX} is, as usual in the case of such measuring devices 16, carried with an average high-frequency f_{HF} lying about in the range between 0.5 and 30 GHz, and is clocked with a pulse repetition frequency f_{PRF}, or rate of fire, set at a frequency range of some megahertz, especially a frequency range of 1 MHz to 10 MHz. This pulse repetition frequency f_{PRF} for turning on the transmission pulse generator 18 is produced by a transmission clock oscillator 22. The high frequency f_{HF} and/or pulse repetition frequency f_{PRF} can, however, in case necessary, also lie above the respectively given frequency ranges.

The transmission signal S_{TX} lying on the signal output of the transmission pulse generator 18 is coupled by means of a transmitting/receiving duplexer 8, especially by means of a directional coupler or hybrid coupler, of the transmitting/receiving unit 2 into the transducer element 20 connected to a first signal output of the transmitting/receiving duplexer 8. Practically at the same time, the transmission signal S_{TX} lies additionally on the second signal output of the transmitting/receiving duplexer 8. The transmission pulse generator 18 and the sampling pulse generator 19 are embodied as usual analog HF-oscillators, e.g. quartz oscillators, back-coupled oscillators or surface acoustic wave filters (SAW).

The reflected measuring signals S_{RX} produced in the above-described manner in the measuring volume of the open or closed, spatial system 4 are, as already explained, received back by the measuring device 16 by means of the transducer element 20 and out-coupled at the second signal output of the transmitting/receiving duplexer 8. As a result, tappable at the second signal output of the transmitting/receiving duplexer 8 is a sum signal S_{TX}+S_{RX} formed by means of the transmission signal S_{TX} and the reflected measuring signal S_{RX}.

Due to the fact that the high-frequency f_{HF} and/or the pulse repetition frequency f_{PRF} of the transmission signal S_{TX}, as usual in the case of such measuring devices 16, are/is set so high that a direct evaluation of the sum signal S_{TX}+S_{RX} lying on the second signal output of the transmitting/receiving duplexer 8, especially a direct measuring of the travel-time t, would no longer be practically possible, or possible only with great technical effort, e.g. use of high-frequency electronics components, the transmitting/receiving unit 8 further includes a sampling circuit 23, which serves for expanding the high-frequency-carried, sum signal S_{TX}+S_{RX}, and, indeed, such that the high-frequency S_{HF} and the pulse repetition frequency f_{PRF} are shifted into a low frequency region of some kilohertz.

For the time expansion of the sum signal S_{TX}+S_{RX}, such is fed to a first signal input of the sampling circuit 23 connected with the second signal output of the transmitting/receiving duplexer 8. Simultaneously with the sum signal S_{TX}+S_{RX}, a burst sequence serving as a sampling signal Sₛₐₘₚₗ is supplied to a second signal input of the sampling circuit 23. A sampling frequency fₛₐₘₚₗ, respectively clock rate, with which the sampling signal Sₛₐₘₚₗ is clocked, is, in such case, set somewhat smaller than the pulse repetition frequency f_{PRF} of the transmission signal S_{TX}.

By means of the sampling circuit 23, the sum signal S_{TX}+S_{RX} is mapped onto an intermediate-frequency signal S_{IF}, which is time-expanded by a transformation factor K_{T} relative to the sum signal S_{TX}+S_{RX} and is, accordingly, low frequency. The transformation factor K_{T}, respectively the time-expansion factor, corresponds, as can be seen in Eq. 1, in such case, to a quotient of the pulse repetition frequency f_{PRF} of the transmission signal S_{TX} divided by a difference of the pulse repetition frequency f_{PRF} of the transmission signal S_{TX} and the sampling frequency fₛₐₘₚₗ of the sampling signal Sₛₐₘₚₗ.

$${K}_{T} = \frac{{f}_{PRF}}{{f}_{Diff}} = \frac{{f}_{PRF}}{{f}_{PRF} - {f}_{Sampl}} \hat{=} \frac{{f}_{HF}}{{f}_{IF}} \qquad ( Eq . 1 )$$

An intermediate-frequency f_{IF} of the so-produced intermediate-frequency signal S_{IF} lies, in the case of such types of measuring devices 16 for ascertaining fill level e, usually in a frequency range of 50 to 200 kHz; in case required, the frequency range can, however, also be chosen higher or lower. A priori, in an old method used in measuring devices 16 of the present assignee, the intermediate-frequency f_{IF} was set fixedly at about 160 kHz, and the filter/amplifier unit 9 was tuned to that via frequency variable components, e.g. rotary coils. The dependence of the intermediate-frequency f_{IF} on the ratio of sampling frequency fₛₐₘₚₗ and pulse repetition frequency f_{PRF} can be derived from Equation 1, as shown in Equation 2.

$${f}_{IF} = {f}_{HF} \cdot ( 1 - \frac{{f}_{Sampl}}{{f}_{PRF}} ) \qquad ( Eq . 2 )$$

In the example of an embodiment of the mixing electronics 1 in FIG. 2, a sampling mixer 24 is used as sampling circuit 23. In the case of the sampling mixer 24, the output signal results from a multiplication of the two input signals. Should there be an unbalanced, or non-ideal, mixing situation, the input signals likewise appear partially in the output signal. The output signal of the sampling mixer 24 contains, as a result, harmonic portions, both in the case of whole-numbered multiples of the difference, as well as also in the case of the sum, of the frequencies of the input signals. A real mixer joins to the input signals an additional noise signal. For these reasons, it is attempted, especially, to suppress the so-called mirror frequency signal Sₘᵢᵣ, the sampling sum signal Sₛₐₘₚₗ+S_{PRF}, their harmonic frequency parts and/or noise signals S_{dist} by a front- or back-connected, frequency-selective filter or by use of an image rejection mixer. By the limiting to a certain narrow bandwidth, e.g. B equals 5-20 kHz, of the mixer, a better optimizing can result as regards gain, noise or linearity.

In this example of an embodiment in FIG. 2, the sampling signal Sₛₐₘₚₗ of the sample clock oscillator 21 triggers a sampling pulse generator 19, whose output signal is coherent with the high frequency signal S_{HF} of the transmission signal S_{TX}. This wave packet, respectively signal burst, of the transmission signal S_{TX} and of the sampling signal Sₛₐₘₚₗ are carried with the same, or with two coherent, high-frequency signal(s) S_{HF} and differ only because the pulse repetition frequency f_{PRF} and the sampling frequency fₛₐₘₚₗ are slightly different. The sampling signal Sₛₐₘₚₗ carried with the high-frequency signal S_{HF} is amplitude-modulated with the sum signal S_{TX}+S_{RX} and then filtered with a lowpass 12. By the filtering of the intermediate-frequency signal S_{IF} with a lowpass 12, the higher frequency signal portions, e.g. mirror frequency signals Sₘᵢᵣ, sampling sum signals Sₛₐₘₚₗ+S_{PRF} and/or noise signals S_{dist}, which arise, for example, also from the mixing, or sampling, procedure, are filtered out.

In the example of the embodiment of the measuring electronics 1 in FIG. 3, used as sampling circuit 23 is a sampling switch 25, especially fast semiconductor transistors or fast diodes. Sampling switches 25 of HF-diodes have, especially, the advantage of extremely short switching times down to the pico-second range, which predestine them for applications in the high-frequency range. Used as fast transistors are, for example, GaAs-MESFET, hetero-bipolar transistors (HBT). Moreover, used as HF-diodes are, for example, fast Schottky diodes. However, any other component, which can be used in the HF region, can also be used.

Sampling switch 25, due to the frequency offset between the pulse repetition frequency f_{PRF} and the sampling frequency fₛₐₘₚₗ, samples the transmission signal S_{TX} in each period at a different phase position, whereby a time-expanded, intermediate-frequency signal S_{IF} results having the above-described transformation factor K_{T}. In the case of sampling switch 25, a fast, bounce-free, electrical switching element, especially an HF-diode or an HF-transistor, is used. Compared with the sampling mixer 24, a stronger disturbance signal S_{dist}, respectively noise, is to be expected from the switching process.

Of course, if required, the intermediate-frequency signal S_{IF}, which is time-expanded relative to the sum signal S_{TX}+S_{RX} by a transformation factor K_{T}, is also pre-amplified in suitable manner by a signal amplifier 11 and can, thus, be matched as regards its signal curve and signal strength P to subsequent control (open- or closed-loop) units 7 and/or evaluating units 6.

For operating the transmitting/receiving unit 2 and for producing the measured value of the fill level M from the intermediate-frequency signal S_{IF}, the measuring device 16 further includes an evaluating unit 6, which likewise can be accommodated in the digital processing unit 5 of the measuring electronics 1, as shown in FIG. 3.

The above-described frequency difference f_{diff}, which results from the difference of the pulse repetition frequency f_{PRF} and the sampling frequency fₛₐₘₚₗ, is ascertained in FIGS. 2 and 3 by a frequency converter 13, or mixer. The frequency converter 13, or mixer, can be embodied either as a digital mixer 13a, especially as an XOR logic chip or a D flip-flop for mixing digital measuring signals S, or as an analog mixer 13b, especially as a diode ring mixer or, generally, a multiplier, for mixing analog measuring signals S. This frequency difference f_{diff} is determined from two bases; first, the operating and triggering of the sampling clock oscillator 21 is checked by this control circuit, and, as required, also the transmission clock oscillator 22 is checked by the control unit 7, and second, from the quotient of the known or measured pulse repetition frequency f_{PRF} and the frequency difference f_{diff}, the transformation factor K_{T} is ascertained in the control unit 7. The sampling clock oscillator 21 and, if required, also the transmission clock oscillator 22 are controllably embodied. As controllable, or tunable, oscillators 21, 22 in the LF-circuit portion 29, for example, voltage-controlled oscillators VCO or digitally or numerically controlled oscillators, e.g. NCO, can be used. The voltage-controlled oscillators VCO can be turned on via drivers 14 of the control unit 7. In the case of use of digital or numerically controlled oscillators, e.g. NCO, these are turned on with digital values directly via a control line or a parallel operating bus 27 of the control unit 7. In the case of use of digitally operating, sampling clock oscillators 21 and/or digitally working, transmission clock oscillators 22, such as shown for example in FIG. 3, the ascertaining of the frequency difference f_{diff} from the pulse repetition frequency f_{PRF} and the sampling frequency fₛₐₘₚₗ is not absolutely necessary, since the digital production of frequencies is done, for example, via a counter, which is set via a whole-numbered divider ratio of the input signals to the feedback signals or via a pulse-pause ratio of the digital signal. Since this digital control circuit is self-regulating and the stable, desired frequency is known, in principle, the determining of the frequency difference f_{diff} by a mixing process can be omitted.

An example of such a digital, phase-coupled control circuit is a phase locked loop, or PLL, whose e.g. free-running, voltage-controlled oscillator (VCO) is divided down by a most-often adjustable divider to a fixed, first, comparison frequency. The phase difference between the first comparison frequency derived from the VCO and a second, most-often quartz-controlled, highly constant comparison frequency, which e.g. also can be transmitted via the control line, or bus, 27, and produced and impressed by the digital processing unit 5, is ascertained in a phase comparator and fed back to the free-running voltage-controlled oscillator as control voltage. In this way, the frequency of the free-running voltage-controlled oscillator is controlled accurately to the whole-numbered multiple of the second, highly constant, comparison frequency set in the divider. These PLL components have only the disadvantage that their current consumption is very high, so that they cannot be used for a low energy, two-conductor device.

The D/A converter, respectively A/D converter, 15 in FIGS. 2 and 3 serve for digitizing and converting or amplifying the analog signals, e.g. filtered intermediate-frequency signal S_{filterIF}, difference signal S_{diff}, with the corresponding frequency values, e.g. intermediate-frequency f_{IF}, frequency difference f_{diff}, so that the following digital control unit 7 which is, for example, an integral part of a digital processing unit 5, respectively a microcontroller 5, can register and process these values. Especially the filtered intermediate-frequency signal S_{filterIF}, which represents the intermediate-frequency signal S_{IF} filtered and modified by the filter/amplifier unit 9, is made discrete, digitized and stored in such a manner that available in a downstream evaluating unit 6 as digital values for the further ascertaining of the measured value of the fill level M are both amplitude as well as also phase information of the intermediate-frequency signal S_{IF}, as well as its transformation factor K_{T}, or time expansion factor. In the control unit 7, the already described signal strength P is determined from the digitized, filtered intermediate-frequency signal S_{filterIF}. With the ascertainment of this signal strength P from the filtered intermediate-frequency signal S_{filterIF} by the control unit 7 and the adjustment opportunity of the intermediate-frequency f_{IF}, respectively frequency difference f_{diff}, by means of operating at least one oscillator 21, 22 by the control unit 7, a control system has been built, which matches the intermediate-frequency f_{IF} to the filter characteristic of the filter/amplifier unit 9 and, consequently, always the optimized, analog, filtered intermediate-frequency signal S_{filterIF}, which is attenuated and changed as little as necessary by the filter/amplifier unit 9, lies on the first output of the measuring electronics 1. At the second output of the measuring electronics 1, for further processing of the analog, filtered, intermediate-frequency signal S_{filterIF}, the time-expansion factor, or the transformation factor K_{T}, is transmitted into the evaluation unit 6.

As evident in FIG. 3, also the evaluation unit 6 and, if required, a bus interface 26 can be integrated into the digital processing unit 5, so that the measuring device 16 communicates by a fieldbus 17 via the bus interface 26 with other measuring devices 16 or with a remote, control location. In the evaluation unit 6, the digitized, filtered, intermediate-frequency signal S_{filterIF} is further processed by a signal processor and signal evaluation algorithms, and travel-time t, respectively fill level e, is determined. An additional line for supplying energy to the measuring device 16 is not present, when the measuring device 16 is a so-called two-conductor measuring device, whose communication and energy supply are cared for exclusively via the fieldbus 17 and simultaneously via a two-wire line. Data transmission, respectively communication, via the fieldbus 17 is accomplished, for example, according to the CAN, HART, PROFIBUS DP, PROFIBUS FMS, PROFIBUS PA or FOUNDATION FIELDBUS standard.

Before the analog-digital conversion, for this purpose, the measuring signals S, e.g. filtered, intermediate-frequency signal S_{filterIF}, difference signal S_{diff}, having the corresponding frequency values, e.g. intermediate-frequency f_{IF}, frequency difference f_{diff}, are fed to the control unit 7, as shown schematically in FIGS. 2 and 3, preferably via a lowpass 12, e.g. a passive or active, RC-filter of predeterminable filter order and adjustable limit frequency fₗ. The lowpass 12 serves for keeping these measuring signals S in the band for preventing aliasing errors, so as to enable a faultless digitizing. The limit frequency fₗ is set according to the known Nyquist sampling theorem, with which the passed portion of the analog measurement signals is sampled and made discrete.

For the case in which the utilized A/D converter 15 is provided for converting exclusively positive signal input values, a reference voltage of the A/D converter 15 is to be correspondingly so set, for example, that an expected, minimum signal input value of the A/D converter 15, e.g. the filtered intermediate-frequency signal S_{filterIF}, sets at least one bit, especially the highest significant bit (MSB).

The transmission clock oscillators 21 and/or for the sampling clock oscillators 22 can, as shown explicitly in FIG. 3, be embodied, for example, as voltage-controlled oscillators VCO or digitally or numerically controlled oscillators NCO, e.g. AD7008 of Analog Devices. The control unit 7 controls these digital oscillators by providing, for example, a corresponding bit value by means of the control line, or bus, 27, from which the voltage-controlled, numeric and/or digital oscillators produce the desired output signal. This form of embodiment is shown explicitly in FIG. 3. However, in the case of use of digital or numeric oscillators 21 and/or 22, which can also be integrated in the digital processing unit 5, respectively the microcontroller, the ascertaining of the frequency difference f_{diff} of the two branches, the transmitting branch with the transmission signal S_{TX} and the sampling branch with the sampling signal Sₛₐₘₚₗ, by the use, for example, of digital frequency converters, respectively digital mixers, 13a can be omitted. By integrating the oscillators 21 and/or 22 into the digital processing unit 5, the frequency difference f_{diff} can also be ascertained directly internally.

The individual regions of the measuring electronics 1, such as transmitting-receiving unit with e.g. HF-circuit portion 28 and LF-circuit portion 29, digital processing unit 5, and their individual branches and components from FIGS. 2 and 3, can be substituted for one another, so that a plurality of different circuit variations is obtained.

FIG. 4 shows the spectrum of the signal after the sampling circuit 23, as filtered by a lowpass 12 and a bandpass 10. Plotted on the abscissa is frequency f and, on the ordinate, the signal amplitude A. Suppressed by the lowpass 12 are, for example, the mirror frequency signals Sₘᵢᵣ, the sampling sum signal Sₛₐₘₚₗ+S_{PRF} produced due to the use of the sampling mixer 24, the sampling signal Sₛₐₘₚₗ and/or pulse repetition signal S_{PRF} partially passed through to the output of the sampling mixer 24 by a mixing process, and higher frequency portions of mix signals from the above signal portions, which superimpose on the intermediate-frequency signal S_{IF} and which are greater than the limit frequency fₗ of the lowpass 12. The mixing of two measuring signals S is understood, in general, to mean a frequency conversion from a HF-frequency f_{HF} to an intermediate-frequency f_{IF}, or also vice versa.

FIG. 4 shows the spectrum of the modulation, or frequency modulation, of the pulse repetition frequency f_{PRF} onto the carrier frequency, or high frequency f_{HF}, and the spectrum of the mixing of the pulse repetition frequency f_{PRF} and the sampling frequency fₛₐₘₚₗ. Frequency f is plotted on the abscissa and signal amplitude A on the ordinate. In the ideal case, the mixing process leads only to difference frequencies f_{diff}, respectively intermediate frequencies f_{IF} and sum frequencies fₛₐₘₚₗ+f_{PRF} of the measuring signals S coupled into the mixer 13, 24.

The mirror frequency fₘᵢᵣ is that frequency, which, mixed with the sampling frequency fₛₐₘₚₗ, produces the same intermediate-frequency f_{IF} on the output of the mixer 13, 24, as is produced with the pulse repetition frequency f_{PRF}. The narrow-band bandpass 10 with bandwidth of, for example, B=5 . . . 20 kHz is used for filtering the lower frequency portions of the noise signal, or disturbance signal, S_{dist} out of the remaining measuring signal S. Bandpass 10 must, therefore, be embodied with components of an appropriate quality. The intermediate-frequency signal S_{IF} is, according to the invention, so matched to this bandpass 10, that the intermediate-frequency f_{IF} and the center frequency f_{cen} of the bandpass 10 are the same. The disturbance signals S_{dist} are influenced and produced, for example, also by the noise behavior of the sampling mixer 24 or also, especially, by the high noise signal of the sampling switch 25. Yet other signal portions and harmonic frequencies of the above-described signal portions can be contained in this spectrum, but these need not be discussed further in this context.

### LIST OF REFERENCE CHARACTERS

1 measuring electronics
2 transmitting/receiving unit
3 fill substance
3a surface
4 open or closed, spatial system
5 digital processing unit, microcontroller
6 evaluation unit
7 open-loop, or closed-loop, control unit
8 transmitting/receiving duplexer
9 filter/amplifier unit
10 bandpass, filter
11 signal amplifier, driver
12 lowpass, filter
13 frequency converter, mixer
13a digital frequency converter, digital mixer
13b analog frequency converter, analog mixer
14 signal amplifier, driver
15 A/D converter, D/A converter
16 measuring device, fill-level measuring device
17 fieldbus
18 transmission pulse generator
19 sampling pulse generator
20 transducer element
20a antenna
20b waveguide
21 sampling clock oscillator, RXO
22 transmission clock oscillator, TXO
23 sampling circuit
24 sampling mixer
25 sampling switch
26 bus interface
27 selecting line, selecting bus
28 HF-portion
29 LF-portion
S measuring signal
S_{TX} transmission signal
S_{HF} high-frequency signal
S_{RX} reflected measuring signal
S_{TX}+S_{RX} signal sum
S_{IF} intermediate-frequency signal
Sₛₐₘₚₗ sampling signal
S_{PRF} pulse repetition signal
S_{filterIF} filtered intermediate-frequency signal
S_{diff} difference signal
S_{dist} disturbance signal, noise signal
Sₘᵢᵣ mirror-frequency signal
Sₛₐₘₚₗ+S_{PRF} sampling sum signal
f_{diff} frequency difference
fₘᵢᵣ mirror frequency
f_{PRF} pulse repetition frequency
f_{IF} intermediate-frequency
f_{HF} high frequency
fₗ limit frequency
f_{cen} center frequency
B bandwidth
K_{T} transformation factor
d distance
h height
e fill level
t travel-time
A amplitude
M measured value of fill level
T1 first method step
T2 second method step
T3 third method step
T4 fourth method step
T5 fifth method step
T6 sixth method step
T7 seventh method step
T8 eighth method step

1-10. (canceled)

11. A method for ascertaining the distance on the basis of travel-time of high-frequency measuring signals, comprising the steps of:
transmitting at least one periodic, pulsed transmission-signal of pulse repetition frequency;
receiving at least one reflected measuring signal;
transforming the transmission signal and the reflected measuring signal by means of a sampling signal having a sampling frequency into a time-expanded, intermediate-frequency signal having an intermediate-frequency;
filtering the time-expanded, intermediate-frequency signal by means of at least one filter and producing a filtered intermediate-frequency signal; and
matching the intermediate-frequency to a limit frequency and/or a center frequency of the filter.

12. The travel-time measuring method as claimed in claim 11, wherein:
the intermediate-frequency is matched by so varying the pulse repetition frequency and/or the sampling frequency, that the frequency difference between the pulse repetition frequency and the sampling frequency is changed.

13. The travel-time measuring method as claimed in claim 12, wherein:
the intermediate-frequency is matched by varying the pulse repetition frequency and/or the sampling frequency according to an iterative method.

14. The travel-time measuring method as claimed in claim 11, wherein:
the matching of the intermediate-frequency is checked by evaluating the signal strength of the filtered intermediate-frequency signal.

15. The travel-time measuring method as claimed in claim 11, further comprising the step of:
periodically introducing a control process or under event-control for the matching of the intermediate-frequency.

16. The travel-time measuring method as claimed in claim 14, wherein:
the signal strength of the filtered intermediate-frequency signal is determined by an algorithm from the filtered intermediate-frequency signal, by ascertaining amplitude of a fill level echo and/or by ascertaining an integral over all data points of the filtered intermediate-frequency signal.

17. The travel-time measuring method as claimed in claim 12, wherein:
a transformation factor, which corresponds to a time-expansion ratio, is ascertained from a pulse repetition frequency to frequency difference ratio.

18. The travel-time measuring method as claimed in claim 17, wherein:
the transformation factor is transmitted for further evaluation and processing of the filtered, time-expanded, intermediate-frequency signal.

19. The travel-time measuring method as claimed in claim 11, wherein:
mirror frequencies of the intermediate-frequency and/or the sampling sum signal are masked out of the time-expanded, intermediate-frequency signal by a lowpass.

20. The travel-time measuring method as claimed in claim 11, wherein:
disturbance signals, especially noise, are masked out of the time-expanded, intermediate-frequency signal by a bandpass.
